(19) United States
(12) Patent Application Publication
(10) Pub. No.: US 2026/0132931 A1
(43) Pub. Date: May 14, 2026

(54) SYSTEMS AND METHODS FOR BATTERY-ASSISTED COOKING IN AN OVEN RANGE APPLIANCE

(71) Applicant: Haier US Appliance Solutions, Inc., Wilmington, DE (US)

(72) Inventor: Eric Scott Johnson, Louisville, KY (US)

(21) Appl. No.: 18/945,622

(22) Filed: Nov. 13, 2024

(51) Int. Cl. F24C 7/08; H02J 9/06

(52) U.S. Cl. CPC F24C 7/087; H02J 9/068

(57) ABSTRACT

A method of operating a cooking appliance including a cabinet, a cooktop mounted to the cabinet and having a cooktop heater, a main power connection to a main supply of electrical power at a first voltage, and an auxiliary power connection to a battery supply of electrical power at a second voltage. The method includes receiving a call for heat from the cooktop heater at a target power level, determining a power schedule utilizing at least one of the main supply or the battery supply, wherein the power schedule is based at least in part on the target power level of the cooktop heater, and operating the cooktop heater in accordance with the power schedule.

### FIELD OF THE INVENTION

The present subject matter relates generally to oven appliances, and more particularly, to systems and methods of battery-assisted cooking in an oven range including an oven chamber and a cooktop.

### BACKGROUND OF THE INVENTION

Conventional residential and commercial cooking appliances generally include a cabinet that includes a cooking chamber (e.g., an oven chamber) for receipt of food items for cooking. Multiple heating elements are positioned within the cooking chamber to provide heat to food items located therein. The heating elements can include, for example, radiant heating elements, such as a bake heating assembly positioned at a bottom of the cooking chamber and/or a separate broiler heating assembly positioned at a top of the cooking chamber. In addition, cooking appliances commonly include a cooktop positioned on top of the oven chamber and having a plurality of gas burners or electric heating elements for heating pots, pans, etc. These cooking appliances are often called “oven range appliances,” “oven ranges,” or simply “ranges.”

Notably, conventional cooking appliances that include electric heating elements in the oven chamber and electric heating elements on the cooktop that are powered by a main electricity supply. However, a user’s kitchen may be wired for a first voltage (e.g., 120VAC for a gas range), requiring rewiring by an electrician to use a conventional electric cooking appliance, cooktop, and/or range that operates at a second voltage (e.g., 240VAC). Accordingly, purchasers of electric cooking appliance may be disappointed when their product cannot be used when installed or when they need to hire an electrician to rewire prior to operation, resulting in user dissatisfaction.

Accordingly, an electric cooking appliance that facilitates operation at a first voltage would be desirable. More specifically, a cooking appliance that is versatile and operates to reduce peak load on the electrical grid, shift energy use to off-peak times, and operate more efficiently would be particularly beneficial.

### BRIEF DESCRIPTION OF THE INVENTION

Aspects and advantages of the invention will be set forth in part in the following description, or may be apparent from the description, or may be learned through practice of the invention.

In one exemplary embodiment, a cooking appliance is provided, including a cabinet, a cooktop mounted to the cabinet and having one or more cooktop heaters, a main power connection to a main supply of electrical power at a first voltage, an auxiliary power connection to a battery supply of electrical power at a second voltage, and a controller operably coupled to the main power connection, the auxiliary power connection, and the one or more cooktop heaters. The controller is configured to receive a call for heat from the one or more cooktop heaters at a target power level, determine a power schedule utilizing at least one of the main supply or the battery supply, wherein the power schedule is based at least in part on the target power level of the one or more cooktop heaters, and operate the one or more cooktop heaters in accordance with the power schedule.

In another exemplary embodiment, a method of operating a cooking appliance is provided. The cooking appliance includes a cabinet, a cooktop mounted to the cabinet and having one or more cooktop heaters, a main power connection to a main supply of electrical power at a first voltage, and an auxiliary power connection to a battery supply of electrical power at a second voltage. The method includes receiving a call for heat from the one or more cooktop heaters at a target power level, determining a power schedule utilizing at least one of the main supply or the battery supply, wherein the power schedule is based at least in part on the target power level of the one or more cooktop heaters, and operating the one or more cooktop heaters in accordance with the power schedule.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front perspective view of a cooking appliance according to an example embodiment of the present subject matter.

FIG. 2 provides a front perspective view of the example cooking appliance of FIG. 1 with a door in the open position according to an example embodiment of the present subject matter.

FIG. 3 provides a side, schematic view of the example cooking appliance of FIG. 1 according to an example embodiment of the present subject matter.

FIG. 4 provides a side, schematic view of a heating system of the example cooking appliance of FIG. 1 according to an example embodiment of the present subject matter.

FIG. 5 provides a side, schematic view of a heating system of the example cooking appliance of FIG. 1 according to another example embodiment of the present subject matter.

FIG. 6 provides an electrical schematic view of a heating system and power switching system of the example cooking appliance of FIG. 1 according to an example embodiment of the present subject matter.

FIG. 7 provides an electrical schematic view of a heating system and power switching system of the example cooking appliance of FIG. 1 according to another example embodiment of the present subject matter.

FIG. 8 provides an electrical schematic view of a heating system and power switching system of the example cooking appliance of FIG. 1 according to another example embodiment of the present subject matter.

FIG. 9 provides a table of potential power supply scenarios for powering an oven chamber heater and a cooktop heater of the example cooking appliance of FIG. 1 according to an example embodiment of the present subject matter.

FIG. 10 provides a method of operating a heating system of the example cooking appliance of FIG. 1 according to an example embodiment of the present subject matter.

FIG. 11 provides a method of operating a heating system of the example cooking appliance of FIG. 1 according to an example embodiment of the present subject matter.

FIG. 12 provides a method of operating a heating system of the example cooking appliance of FIG. 1 according to an example embodiment of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As explained herein, aspects of the present subject matter are generally directed to a control system that powers an oven, a cooktop, and/or a cooking range using a combination of mains electric supply and battery power. The construction may enable a method that maximizes power use from the main supply, extending battery life. The cooking range, the electric cooktop, and/or the oven heater may include a power connection to mains supply with a first voltage (e.g., 120VAC), a battery with a second voltage (e.g., 230VDC), and a controller that receives and distributes power to heaters. One or more switches may be utilized that gate power to oven and/or cooktop heaters from main supply and/or battery. Further, one or more oven heaters may include two or more stages, one powered from main supply and another powered from battery.

According to an example embodiment, oven heaters may be powered from a main supply at a first voltage (e.g., 120VAC) and/or a battery at a second voltage (e.g., 230VDC). One or more switches (e.g., relays, contactors, or transistors) may be used to gate power from the two sources to one or more oven heaters on their high-voltage side, and an additional one or more switches may be used to gate power to the two sources return on the heater’s low-voltage side. These switches may be wired for each heater such that when the switch on the high-voltage side draws power from a first source, the switch on the low-voltage side may be adjusted to return power to the first source (and similarly for the second source).

According to another example embodiment, the oven heaters may be resistance heaters. The resistance of each heater (e.g., 18.75ohms) and the voltage at which it is powered determine its power output. When powered at the first voltage (e.g., 120VAC), a heater produces a first power (e.g., 768W), and when powered at a second voltage (e.g., 230VDC), that heater produces a second power (e.g., 2,821W). Cooking algorithms may be configured to adjust the power source of one or more oven heaters to minimize power drawn from battery by maximizing use of main power. Further, heaters with more than one stage (e.g., two heaters placed in proximity on the same face of the oven chamber) may be connected such that a first heater stage is powered by a main supply at a first voltage and a second heater stage is powered by a battery at a second voltage. This construction enables first and second heater stages to be powered at the same time, producing higher power output than the single-stage heater construction above while retaining the option to power the heater at one or more lower-power levels from either the main supply or battery.

According to an example embodiment, cooktop heaters may be powered from a main supply at a first voltage (e.g., 120VAC) and/or a battery at a second voltage (e.g., 230VDC). The voltage from the main supply may be transformed to a third voltage and/or may be rectified to DC from AC or vice versa (e.g., 230VDC), such that the input power to the cooktop heaters is similar from both sources. One or more switches (e.g., relays, contactors, or transistors) may be used to gate power from the two sources to one or more cooktop heaters on their high-voltage side, and an additional one or more switches may be used to gate power to the two sources’ return on the heater’s low-voltage side. These switches may be wired such that when the switch on the high-voltage side draws power from the first source, the switch on the low-voltage side is adjusted to return power to the first source (and similarly for the second source).

According to an example embodiment, a general method of operating an oven or a cooktop may use, for each oven and cooktop setting, a controller that calculates one or more power schedules (e.g., heaters to be powered, heater power sources, power levels, and/or on/off timings that correspond to one or various cooking scenarios). These power schedules may be dependent on whether one or both of the oven and the cooktop are calling for heat, whether the oven is preheating or in steady state cooking mode, whether the oven is set to bake or broil, etc.

According to an example embodiment, an induction cooktop system can be powered from the main supply and/or the battery. One or more switches may be used that switch power to the oven and/or cooktop heaters from either the main supply or the battery. For example, an induction cooktop system may be powered by both a main supply with a first voltage (e.g., 120V) (either directly or via a transformer to second voltage) and a battery supply with a second voltage (e.g., 230V) at the same time. If the total cooktop set power is less than a main power max threshold (e.g., 1,700W), then the cooktop may be powered from the main supply. By contrast, if the total cooktop set power is greater than a main power max threshold (e.g., 1,700W), then the cooktop may be powered from both the main supply and the battery. If the total cooktop set power is greater than the battery and main supply power max threshold (e.g., 8,600W), then the total cooktop power may be limited to the battery and main supply max threshold by reducing power of one or more heaters.

According to another example embodiment, an induction cooktop system may be powered by either a main supply with a first voltage (e.g., 120V) (either directly or via a transformer to second voltage) or a battery supply with a second voltage (e.g., 230V). If the total cooktop set power is less than a main power max threshold (e.g., 1,700W), then the cooktop may be powered from the main supply. If the total cooktop set power is greater than a main power max threshold (e.g., 1,700W), then the cooktop may be powered from the battery. If the total cooktop set power is greater than a battery power max threshold (e.g., 6,900W), then the total cooktop power may be limited to the battery power max threshold by reducing power of one or more heaters.

According to another example embodiment, an induction cooktop system may be powered by a battery supply. If the total cooktop set power is greater than a battery power max threshold (e.g., 6,900W), then the total cooktop provided power may be limited to the battery power max threshold by reducing power of one or more heaters.

According to an example embodiment, the method may include switching between mains supply and/or battery power during a heating mode. For example, when the oven calls for heat and is set to broil (e.g., a high-power mode with one heater), the broil heater may be powered from the battery. If the oven includes a broil heater with more than one stage, the first broil heater stage may be powered using the battery and the second broil heater stage may be powered from the main supply. Furthermore, if the oven is preheating, then oven heaters may be powered using both main supply and battery, or by the battery only. When the oven is in a steady state cooking mode, the oven heaters may be powered from the main supply only, or both the main supply and the battery.

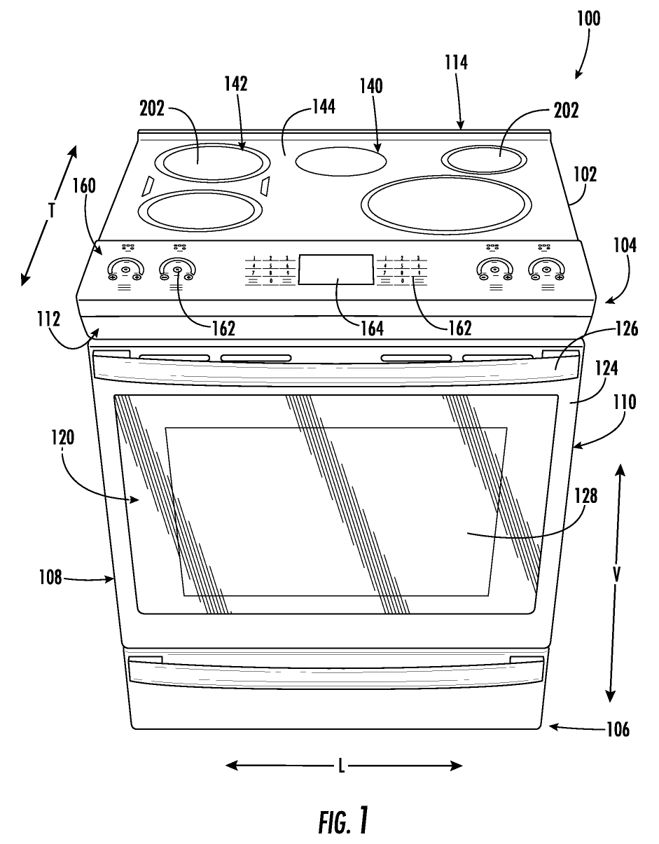

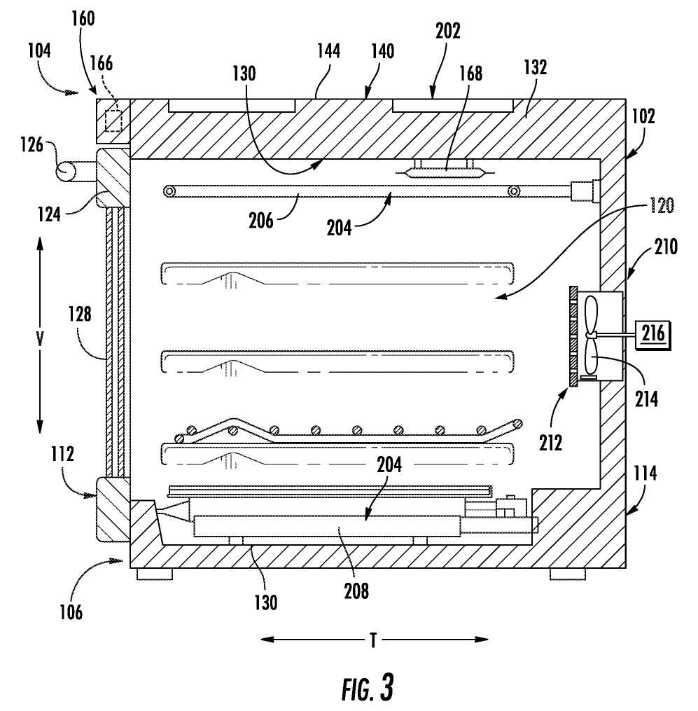

FIG. 1 provides a front, perspective view of a cooking appliance 100 as may be employed with the present subject matter. Cooking appliance 100 generally defines a vertical direction V, a lateral direction L, and a transverse direction T, each of which is mutually perpendicular, such that an orthogonal coordinate system is generally defined. As illustrated, cooking appliance 100 includes an insulated cabinet 102. Cabinet 102 of cooking appliance 100 extends between a top 104 and a bottom 106 along the vertical direction V, between a first side 108 (left side when viewed from front) and a second side 110 (right side when viewed from front) along the lateral direction L, and between a front 112 and a rear 114 (FIG. 3) along the transverse direction T.

Within cabinet 102 is a single cooking chamber 120 which is configured for the receipt of one or more food items to be cooked. However, it should be appreciated that cooking appliance 100 is provided by way of example only, and aspects of the present subject matter may be used in any suitable cooking appliance, such as a double oven range appliance. Thus, the example embodiment shown in FIG. 1 is not intended to limit the present subject matter to any particular cooking chamber configuration or arrangement. Indeed, aspects of the present subject matter may be applied to any suitable cooking appliance.

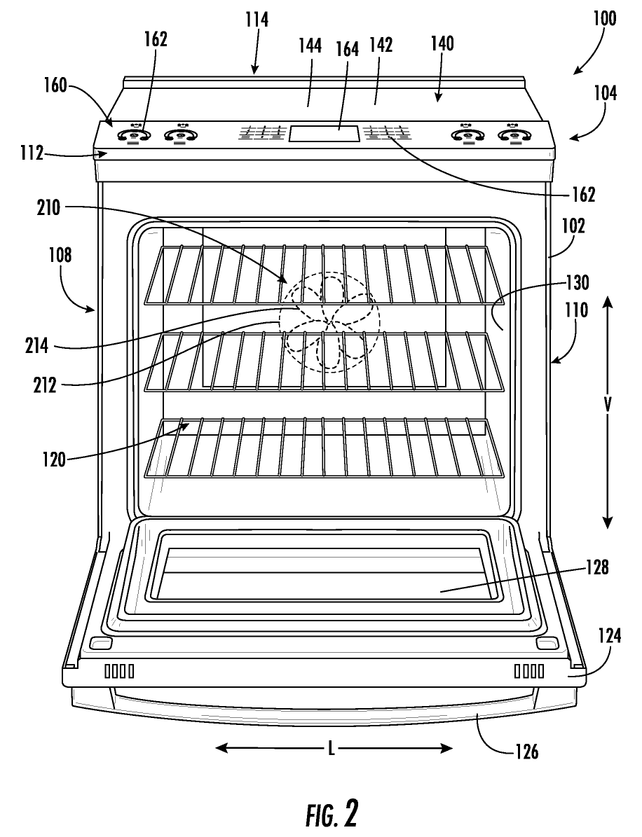

Referring now also to FIGS. 2 and 3, cooking appliance 100 includes a door 124 rotatably attached to cabinet 102 in order to permit selective access to cooking chamber 120. Handle 126 is mounted to door 124 to assist a user with opening and closing door 124 in order to access cooking chamber 120. As an example, a user can pull on handle 126 mounted to door 124 to open or close door 124 and access cooking chamber 120. One or more transparent viewing windows 128 (FIG. 1) may be defined within door 124 to provide for viewing the contents of cooking chamber 120 when door 124 is closed and also assist with insulating cooking chamber 120.

Cooking chamber 120 is defined by a plurality of chamber walls 130. Specifically, cooking chamber 120 may be defined by a top wall, a rear wall, a bottom wall, and two sidewalls 130. These chamber walls 130 may be joined together to define an opening through which a user may selectively access cooking chamber 120 by opening door 124. In order to insulate cooking chamber 120, cooking appliance 100 includes an insulating gap defined between the chamber walls 130 and cabinet 102. According to an exemplary embodiment, the insulation gap is filled with an insulating material 132, such as insulating foam or fiberglass, for insulating cooking chamber 120.

Cooking appliance 100 also includes a cooktop 140. Cooktop 140 is positioned at or adjacent top 104 of cabinet 102 such that it is positioned above cooking chamber 120. Specifically, cooktop 140 includes a top panel 142 positioned proximate top 104 of cabinet 102. By way of example, top panel 142 may be constructed of glass, ceramics, enameled steel, and combinations thereof. For example, according to the illustrated embodiment, cooktop includes a ceramic glass panel 144 having a plurality of cooking zones.

Although aspects of the present subject matter are described herein in the context of a single cooking appliance, it should be appreciated that cooking appliance 100 is provided by way of example only. Other oven or range appliances having different configurations, different appearances, and/or different features may also be utilized with the present subject matter, e.g., double ovens, standalone cooktops, etc.

As illustrated, cooking appliance 100 may generally include a user interface panel 160 that is located within convenient reach of a user of the cooking appliance 100. For example, according to the illustrated embodiment, user interface panel 160 is mounted at a front 112 and top 104 corner of cabinet 102, e.g., directly above door 124. Although user interface panel 160 is illustrated as being mounted at a top, front of cabinet 102, it should be appreciated that aspects of the present subject matter may be applicable to other mounting locations of control panels, e.g., such as front mount control panels, rear mount panels, etc. In addition, it should be appreciated that the present subject matter is not limited oven applications but could instead be applied to any other suitable appliance.

For this example embodiment, user interface panel 160 includes control inputs 162 that are each associated with one or more heating elements of cooking appliance 100. In this manner, control inputs 162 allow the user to activate each heating element and determine the amount of heat input provided by each heating element to a cooking food items within cooking chamber 120 or on cooktop 140. Although control inputs 162 are illustrated as touch-sensitive or contact inputs, it should be understood that control inputs 162 and the configuration of cooking appliance 100 shown in FIG. 1 is provided by way of example only. More specifically, user interface panel 160 may include various input components, such as one or more of a variety control knobs, electrical, mechanical or electro-mechanical input devices including rotary dials, push buttons, and touch pads. User interface panel 160 may also be provided with one or more graphical display devices or display components 164, such as a digital or analog display device designed to provide operational feedback or other information to the user such as e.g., whether a particular heating element is activated and/or the rate at which the heating element is set.

User interface panel 160 may be in direct operative communication with a controller 166 of cooking appliance 100, such that user inputs via user interface panel 160 may be directly used to regulate operation of various components of cooking appliance 100. User interface panel 160 of cooking appliance 100 may be in communication with controller 166 via, for example, one or more signal lines or shared communication busses, and signals generated in controller 166 operate cooking appliance 100 in response to user input via user input devices 162. Input/Output ("I/O") signals may be routed between controller 166 and various operational components of cooking appliance 100 such that operation of cooking appliance 100 can be regulated by controller 166.

Controller 166 is a “processing device” or “controller” and may be embodied as described herein. Controller 166 may include a memory and one or more microprocessors, microcontrollers, application-specific integrated circuits (ASICS), CPUs or the like, such as general or special purpose microprocessors operable to execute programming instructions or micro-control code associated with operation of cooking appliance 100, and controller 166 is not restricted necessarily to a single element. The memory may represent random access memory such as DRAM, or read only memory such as ROM, electrically erasable, programmable read only memory (EEPROM), or FLASH. In one embodiment, the processor executes programming instructions stored in memory. The memory may be a separate component from the processor or may be included onboard within the processor. Alternatively, controller 166 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

In addition, controller 166 may also be communication with one or more sensors, such as temperature sensor 168 (FIG. 3), which may be used to measure temperature inside cooking chamber 120 and provide such measurements to the controller 166. As used herein, “temperature sensor” or the equivalent is intended to refer to any suitable type of temperature measuring system or device positioned at any suitable location for measuring the desired temperature. Thus, for example, temperature sensor 168 may each be any suitable type of temperature sensor, such as a thermistor, a thermocouple, a resistance temperature detector, a semiconductor-based integrated circuit temperature sensor, etc. In addition, temperature sensor 168 may be positioned at any suitable location and may output a signal, such as a voltage, to a controller that is proportional to and/or indicative of the temperature being measured. Although exemplary positioning of temperature sensors is described herein, it should be appreciated that cooking appliance 100 may include any other suitable number, type, and position of temperature and/or other sensors according to alternative embodiments.

Referring now generally to FIGS. 1 through 5, a heating system 200 of cooking appliance will be described according to an example embodiment of the present subject matter. Cooking appliance 100 may further include one or more heating elements or cooktop heaters (identified generally by reference numeral 202) for selectively heating cooking utensils positioned on glass panel 144. For example, referring to FIG. 1, cooktop heaters 202 may be electric heating elements or induction heating elements. Specifically, a plurality of cooktop heaters 202 are mounted within or on top of top panel 142 underneath a glass panel 144 that supports cooking utensils over the cooktop heaters 202 while cooktop heaters 202 provide thermal energy to cooking utensils positioned thereon, e.g., to heat food and/or cooking liquids (e.g., oil, water, etc.).

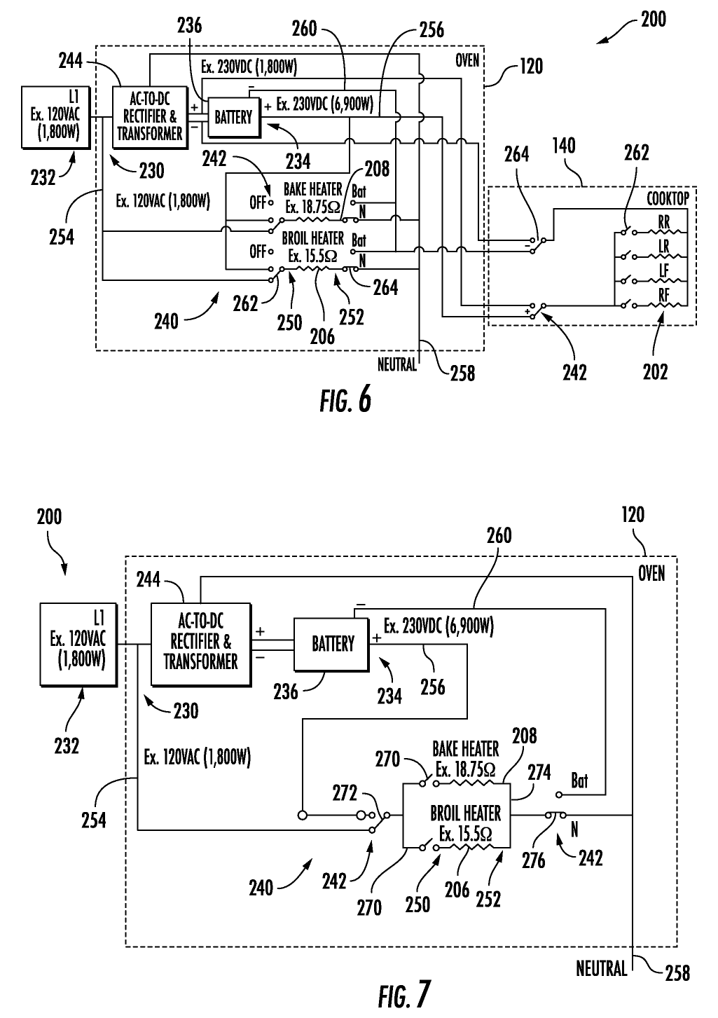

Cooktop heaters 202 can be configured in various sizes so as to provide e.g., for the receipt of cooking utensils (i.e., pots, pans, etc.) of various sizes and configurations and to provide different heat inputs for such cooking utensils. For example, as shown in FIG. 1, cooktop 140 includes five cooktop heaters 202 of different sizes, each of which may be independently controlled to facilitate operation of cooktop 140. By contrast, as shown in the schematic representation of FIG. 6, cooktop 140 may include four cooktop heaters 202, e.g., a rear right heater (RR), a left rear heater (LR), a left front heater (LF), and a right front heater (RF). According to alternative embodiments, cooking appliance 100 may have other cooktop configurations or burner elements.

In addition, cooking appliance 100 may include one or more chamber heaters 204 that may be positioned within or may otherwise be in thermal communication with cooking chamber 120 for regulating the temperature within cooking chamber 120. Specifically, an upper chamber heater, also referred to as a broil heating element 206, may be positioned in cabinet 102, e.g., at a top portion of cooking chamber 120, and a lower chamber heater, also referred to as a bake heating element 208, may be positioned at a bottom portion of cooking chamber 120. Broil heating element 206 and bake heating element 208 may be used independently or simultaneously to heat cooking chamber 120, perform a baking or broil operation, perform a cleaning cycle, etc. The size and heat output of heating elements 206, 208 can be selected based on the, e.g., the size of cooking appliance 100 or the desired heat output. According to example embodiments, broil heating element 206 and bake heating element 208 are electric heating elements. Cooking appliance 100 may include any other suitable number, type, and configuration of heating elements 202 within cabinet 102 and/or on cooktop 140.

In some embodiments, cooking appliance 100 includes a convection heating assembly 210 that operates in conjunction with chamber heaters 204 (e.g., broil heating element 206 and bake heating element 208) to facilitate convection cooking within cooking chamber 120. In this regard, convection heating assembly 210 may operate to circulate a flow of heated air within cooking chamber 120 to facilitate more even heating and shorter cooking cycle times. Although an example convection heating assembly 210 is described below, it should be appreciated that variations and modifications may be made while remaining within the scope of the present subject matter.

As best shown in FIG. 3, convection heating assembly 210 includes a convection fan enclosure 212 positioned proximate a rear of cooking chamber 120. In this regard, convection fan enclosure 212 is defined at least partially by a front wall and a rear wall spaced apart along the transverse direction T. The front wall may define one or more apertures that permit the flow of heated air to pass into and out of convection fan enclosure 212. According to alternative example embodiments, convection fan enclosure 212 may include alternative airflow paths, ducts, or other flow regulating devices for directing the flow of heated air within convection fan enclosure 212 and throughout cooking chamber 120.

As illustrated, convection heating assembly 210 further includes a convection fan 214 mounted in cabinet 102 (e.g., within convection fan enclosure 212) for circulating the flow of heated air in cooking chamber 120. Specifically, convection fan 214 is illustrated as a centrifugal fan, though other suitable fan types and configurations are possible and within the scope of the present subject matter. A drive motor 216 may be mounted to cabinet 102 and may be mechanically coupled to convection fan 214 for selectively rotating convection fan 214. Controller 166 may be in operative communication with drive motor 216 for selectively rotating convection fan 214 at desired times within a cooking cycle.

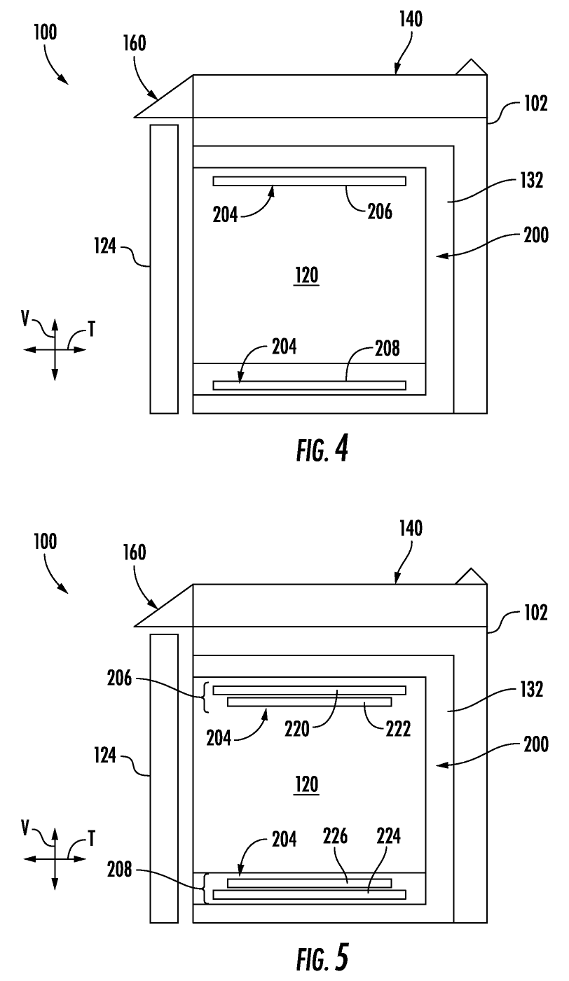

Referring now specifically to FIG. 5, each chamber heater 204 may include one or more heating stages that may be powered collectively or independently depending on the heating needs of cooking chamber 120 or the power available to cooking appliance 100. For example, as illustrated, broil heating element 206 may include a first heating stage 220 and a second heating stage 222. Similarly, bake heating element 208 may include a first heating stage 224 and a second heating stage 226. In general, the term “heating stages” may refer to subsets of chamber heaters 204 that are positioned adjacent to each other on the same face of the oven chamber or are embodied as a single heating element but which may be independently operated. According to example embodiments, these heating stages may each include different resistances, thereby facilitating versatility in the heating power applied through chamber heaters 204. Other variations and modifications to chamber heaters 204 and their respective heating stages are possible and within the scope of the present subject matter.

Referring now also to FIGS. 6 through 8, electrical schematic views of heating system 200 will be described according to example embodiments of the present subject matter. As shown, heating system 200 may include a main power connection 230 to a main supply 232 of electrical power and an auxiliary power connection 234 to a battery supply 236. In this regard, cooking appliance 100 may be an electric oven that facilitates battery-assisted cooking. According to an example embodiment, main supply 232 may provide power at a first voltage (e.g., 120VAC) and battery supply 236 may provide power at a second voltage (e.g., 230VDC). It should be appreciated that these supply voltages may vary, and additional or alternative power sources may be incorporated into heating system 200 while remaining within the scope of the present subject matter.

According to example embodiments, main supply 232 may be mains electricity, e.g., provided by a utility provider to a conventional 120VAC outlet within a user’s residence. Battery supply 236 may be a battery supply or battery bank stored within cabinet 102 of cooking appliance 100 or may be a home battery supply electrically coupled or wired to cooking appliance 100. According to example embodiments, controller 166 may have a communication link with battery supply 236 (e.g., a remote connection with the home battery supply) for receiving operating parameters of battery supply 236, e.g., such as operating voltage, a maximum battery supply power draw, or other useful information.

As noted above, conventional cooking appliances that include electric heating elements in the oven chamber and electric heating elements on the cooktop are powered by a main electricity supply. However, a user’s kitchen may be wired for a first voltage (e.g., 120VAC for a gas range), requiring rewiring by an electrician to use a conventional electric oven, cooktop, and/or range that operates at a second voltage (e.g., 240VAC). Accordingly, purchasers of electric cooking appliances may be disappointed when their product cannot be used when installed or may need to hire an electrician to rewire prior to operation, resulting in user dissatisfaction. Heating system 200 may solve this problem by facilitating operation at a higher voltage, e.g., via use of power electronics and a higher voltage battery supply 236. Aspects of the present subject matter are directed to heating system 200 and power control systems and methods for facilitating such battery-assisted operation of cooking appliance 100.

In this regard, referring still to FIGS. 6 through 8, heating system 200 may include a power switching system 240 configured to selectively couple main supply 232 and battery supply 236 to various heating elements of heating system 200. In this regard, power switching system 240 may include one or more switches 242, power electronics, power busses, and other electricity regulating devices for controlling the flow of power throughout heating system 200. In this regard, switches 242 may include single pole double throw relays, double pole double throw relays, contactors, transistors, or any other suitable devices for toggling, switching, or regulating the flow of electricity.

Power switching system 240 may also include a power electronics system 244 for converting alternating current (AC) power to direct current (DC) power or for converting DC power to AC power. For example, power electronics system 244 may include one or more inverters, rectifiers, voltage transformers, or other power electronics devices for converting power from AC to DC power (and vice versa), for adjusting voltage output, or for otherwise regulating or manipulating the flow of electricity as needed based on the call for heat from heating system 200.

According to the illustrated example embodiments, each heating element in heating system 200 (e.g., cooktop heaters 202 and chamber heaters 204) may include a high-voltage side 250 and a low-voltage side 252. Power switching system 240 may operate to selectively couple high-voltage sides 250 with a line connection 254 of main supply 232 or a positive terminal 256 of battery supply 236, e.g., based on a command from controller 166. Similarly, power switching system 240 may operate to selectively couple low-voltage sides 252 with a neutral line 258 of main supply 232 or a negative terminal 260 of battery supply 236, e.g., based on a command from controller 166.

As explained above, power switching system 240 includes one or more switches 242 to route power within power switching system 140 and heating system 200. For example, as illustrated in FIG. 6, switches 242 may include a high-side switch 262 for selectively coupling high-voltage side 250 of a particular heating element to line connection 254 of main supply 232 or positive terminal 256 of battery supply 236. In addition, switches 242 may include a low-side switch 264 for selectively coupling low-voltage side 252 to neutral line 258 of main supply 232 or negative terminal 260 of battery supply 236. As illustrated, high-side switches 262 and low-side switches 264 may be used to selectively route power to one or more cooktop heaters 202 and/or one or more chamber heaters 204.

According to another example embodiment, instead of having a high-side switch 262 and a low side switch 264 for each of two heating elements (e.g., four total switches), a first chamber heater, e.g., such as broil heating element 206, may be hard-wired to negative terminal 260 of battery supply 236, and a second chamber heater, e.g., such as bake heating element 208, may be hard-wired to neutral line 258 of main supply 232. According to such an embodiment, power switching system 240 may include a single battery supply switch for selectively coupling first heating element (e.g., broil heating element 206) to battery supply 236 and a line supply switch for selectively coupling the second heating element (e.g., bake heating element 208) to main supply 232.

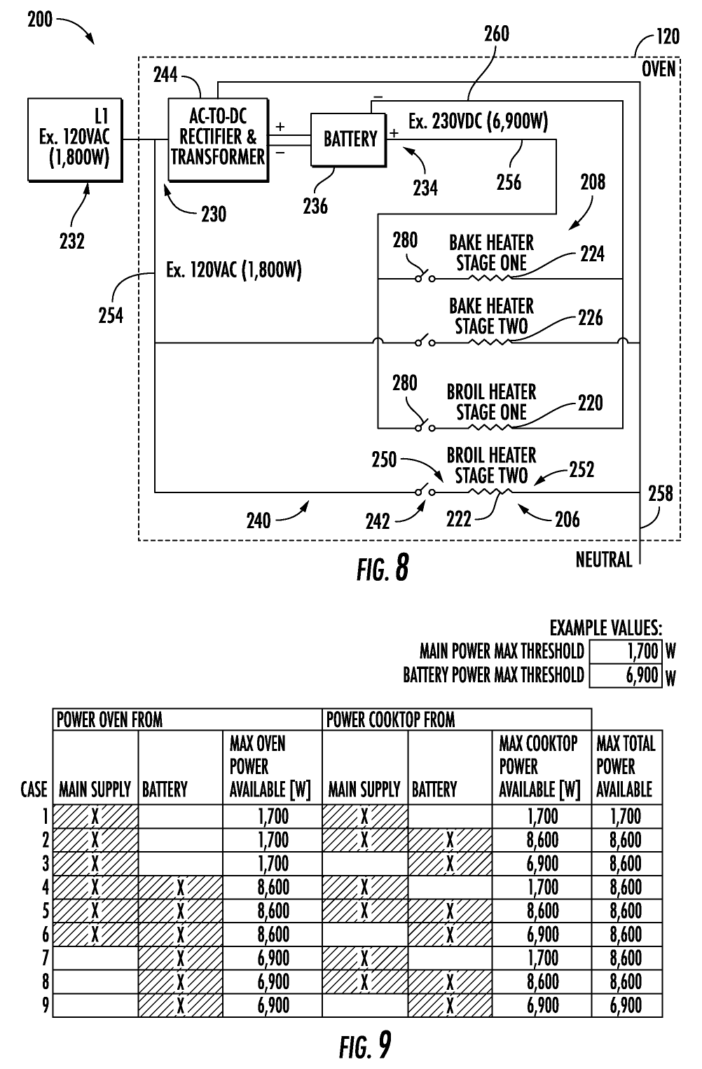

Referring now specifically to FIG. 7, according to an example embodiment, power switching system 240 may include a high-side voltage bus 270 electrically coupled to high-voltage side 250 of a first heating element (e.g., bake heating element 208) and high-voltage side 250 of a second heating element (e.g., broil heating element 206). In addition, a first bus supply switch 272 may be configured to selectively couple high-side voltage bus 270 to main supply 232 or battery supply 236. In addition, a low-side voltage bus 274 may be electrically coupled to low-voltage side 252 of a first heating element (e.g., bake heating element 208) and the low-voltage side 252 of a second heating element (e.g., broil heating element 206). A second bus supply switch 276 may selectively couple low-side voltage bus 274 to main supply 232 or battery supply 236.

The configurations of power switching system 240 described herein may also be useful or applicable to heating elements having multiple heating stages. For example, as illustrated in FIG. 8, broil heating element 206 includes first heating stage 220 and second heating stage 222. Similarly, bake heating element 208 includes first heating stage 224 and second heating stage 226. As shown, a plurality of heater stage switches 280 may be operably coupled to each heating stage for selectively coupling these stages to one of main supply 232 or battery supply 236. Specifically, as illustrated, one stage of the bake/broil heaters (e.g., first heating stages 220/224) are only connected to battery supply 236 and the other stage of the bake/broil heaters (e.g., second heating stages 222/226) is only connected to main supply 232. It should be appreciated that aspects of power switching system 240 are interchangeable among embodiments described herein. For example, each heating stage 220-226 may include a dedicated high-side switch 262 and a dedicated low-side switch 264.

In addition, power switching system 240 may use the same or similar features to regulate the flow of power to cooktop heaters 202 of cooktop 140. In this regard, power switching system 240 may include a high-side switch 262 for selectively coupling a high-voltage side 250 of the plurality of cooktop heaters 202 to line connection 254 of main supply 232 (e.g., through power electronics system 244 or a transformed line connection) or positive terminal 256 of battery supply 236. Similarly, power switching system 240 may include a low-side switch 264 for selectively coupling low-voltage side 252 of the plurality of cooktop heaters 202 to neutral line 258 of main supply 232 (e.g., through power electronics system 244 or a transformed line connection) or negative terminal 260 of battery supply 236. Other switching configurations are possible and within the scope of the present subject matter.

As will be explained in more detail below, controller 166 may be in operative communication with power switching system 240 to regulate power flow based at least in part on the call for heat from each respective heating element (e.g., cooktop heaters 202 and/or chamber heaters 204). In this regard, controller 166 may be configured to receive a call for heat from the heating element (e.g., based on a user input via control inputs 162, a change in system state, etc.), determine a power schedule utilizing at least one of main supply 232 or battery supply 236, and operate power switching system 240 to deliver power to the heating element from at least one of 232 main supply or battery supply 236 in accordance with the power schedule. According to an example embodiment, the power schedule minimizes power drawn from battery supply 236. In addition, in cases where a chamber heater 204 includes two stages, the power schedule may include powering first stage 220/224 using only battery supply 236 and powering second stage 222/226 using only main supply 232.

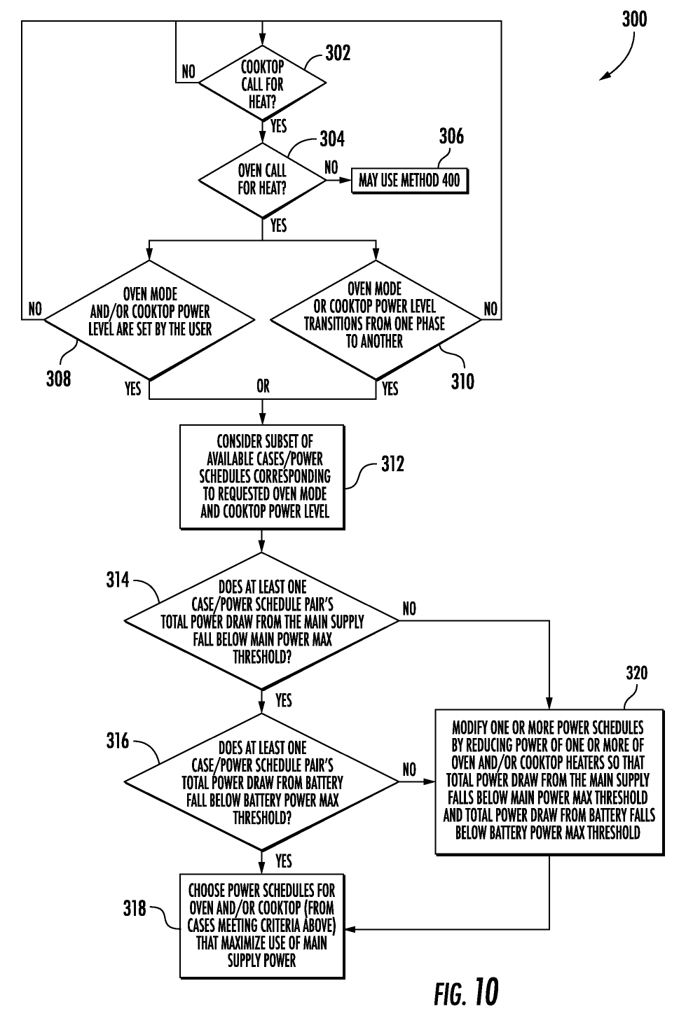

Referring now to FIG. 9, various power supply scenarios for powering cooktop heaters 202 and/or chamber heaters 204 using main supply 232 and/or battery supply 236 will be described according to an example embodiment. For example, because each of cooktop heaters 202 and/or chamber heaters 204 may be powered by main supply 232, battery supply 236, or both, the total number of power supply scenarios may include nine scenarios, as shown in FIG. 9. To facilitate discussion, example max available power thresholds are provided for each of main supply 232 and battery supply 236. In this regard, the maximum main supply power threshold of main supply 232 may be 1,700 Watts and the maximum battery supply power threshold of battery supply 236 may be 6,900 Watts. As shown, for each power supply scenario, there is a maximum total power available to both cooktop heaters 202 and/or chamber heaters 204 (i.e., listed in the last column of FIG. 9). It should be appreciated that the power values provided are only exemplary and are not intended to limit the scope of the present subject matter in any manner.

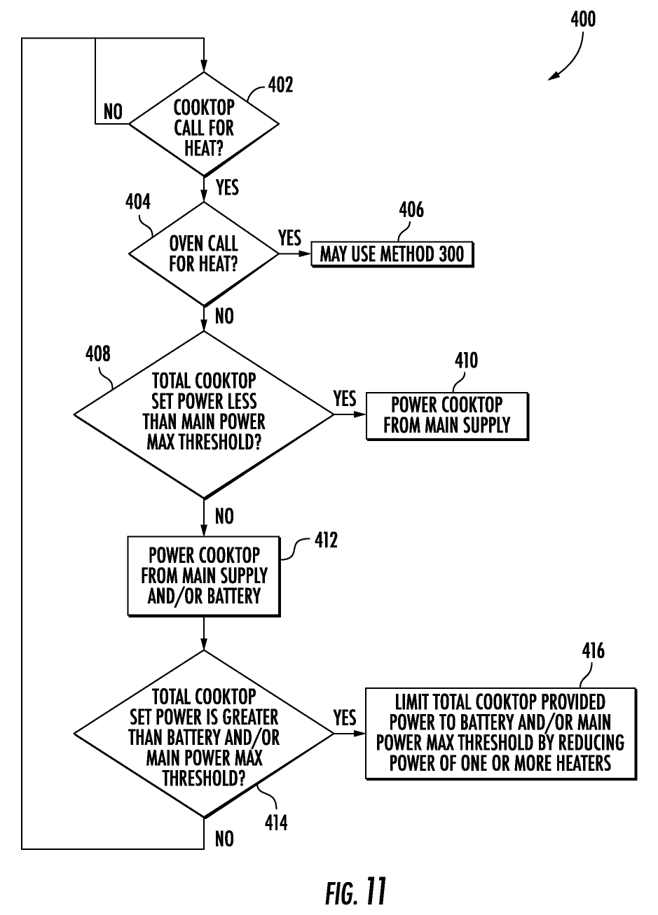

Referring now to FIG. 10, an example method 300 of operating a battery-assisted heating system in a cooking appliance will be described according to an example embodiment. For example, method 300 may be used to operate heating system 200 of cooking appliance. As shown, step 302 includes determining whether cooktop 140 is calling for heat. In this regard, a cooktop call for heat may occur when one or more cooktop heaters 202 are turned on, e.g., via user manipulation of control inputs 162. If cooktop 140 is calling for heat, step 304 may include determining whether the oven is calling for heat, e.g., whether cooking chamber 120 needs to be heated. If the oven is not calling for heat, i.e., only cooktop 140 is calling for heat, step 306 may include using an alternate method to operate cooktop 140 (e.g., method 400 described in more detail below).

If both cooktop 140 and cooking chamber 120 are calling for heat, step 308 may include determining whether the oven mode and/or cooktop power level have been set or manipulated by the user. Step 310 may include determining whether the oven mode or cooktop power level transitions from one phase to another (e.g., from a preheat mode to a steady state cooking mode). If either of steps 308 or 310 are true, step 312 may include considering the power supply scenarios provided in FIG. 9 in view of the requested oven mode, power levels requested from cooktop heaters 202 and/or chamber heaters 204, etc. In this regard, method 300 may include selecting a target power supply scenario from a list of potential power supply scenarios, and this selection may occur when a user provides a control input, when there is a transition in oven modes, or when there is a change in a set temperature or power of chamber heater 204 or cooktop heater 202. Each power supply scenario may comprise at least one power schedule that defines, for both oven and cooktop heaters, the heaters to be powered, heater power sources, power levels, and/or on/off timings.

Step 314 may include determining whether there is at least one power supply scenario where application of that power supply scenario would result in the total power draw from main supply 232 falling below a maximum main supply power threshold. For example, if application of one or more power supply scenarios would result in a power draw from main supply 232 that is equal to or less than 1,700W, method 300 may proceed to step 316.

Step 316 may include determining whether there is at least one power supply scenario where application of that power supply scenario would result in the total power draw from battery supply 236 falling below a maximum battery supply power threshold. For example, if application of one or more power supply scenarios would result in a power draw from battery supply 236 that is equal to or less than 6,900W, method 300 may proceed to step 318. The maximum battery supply power threshold may be a fixed value or may vary based on battery characteristics (e.g., state of charge, state of health, temperature, etc.).

At step 318, any of the power supply scenarios that met the requirements of steps 314 and 316 are considered to determine which should be used. In this regard, the reduced list of potential power supply scenarios may be considered by controller 166, which may select the power supply scenario that maximizes the use of power from main supply 232 and/or minimizes the use of power from battery supply 236. By contrast, if steps 314 or 316 result in a determination that the total power draw from either the main supply or the battery supply would exceed their respective maximum power threshold for all power supply scenarios, step 320 may include modifying one or more of the power schedules for the cooktop and/or oven that make up the power supply scenarios. Modifying one or more power schedules may include reducing power supplied to one or more of cooktop heaters 202 and/or chamber heaters 204, e.g., such that the total power draw from both the main supply and the battery supply falls below their respective maximum power thresholds.

In other words, the potential power supply scenarios may be used to determine whether power is provided from the main supply, the battery supply, or both the main supply and the battery supply. Method 300 may include receiving calls for heat from cooktop heaters 202 and chamber heaters 204, along with their respective power levels. Method 300 may further include selecting a target power supply scenario from a list of potential power supply scenarios, e.g., based at least in part on comparisons of a total main supply power draw to a maximum main supply power threshold and a total battery supply power draw to a maximum battery supply power threshold. In addition, for example, selecting the target power supply scenario from the list of potential power supply scenarios may include selecting the scenario that maximizes power draw from the main supply or minimizes power draw from the battery supply. Method 300 may further include operating chamber heaters 204 and/or cooktop heaters 202 in accordance with the target power supply scenario.

For example, step 318 of selecting the target power supply scenario may include determining that the combined oven and cooktop power draw falls below a maximum main supply power threshold and operating both the chamber heater and the cooktop heater using the main supply. In this regard, if the cooktop heaters 202 and/or chamber heaters 204 are collectively requesting less than the maximum main supply power threshold (e.g., 1,700W), both cooktop heaters 202 and/or chamber heaters 204 may be operated solely from main supply 232, thereby conserving battery power of battery supply 236.

Step 318 of selecting the target power supply scenario may include determining, for each power supply scenario of the list of potential power supply scenarios, a total power draw (consisting of at least a cooktop power draw plus an oven power draw) and a maximum total power threshold (including at least a maximum battery supply power threshold plus an optional maximum main supply power threshold) and removing power supply scenarios from the list of potential power supply scenarios where the total power draw exceeds the maximum total power threshold.

Step 318 of selecting a target power supply scenario from a list of potential power supply scenarios may further include prioritizing usage of main supply 232 or battery supply 236 based on the oven operating mode, e.g., whether the mode is a “high power” or a “low power” mode of operation. For example, step 318 may include determining that the cooking appliance is operating in a preheat mode of operation or a broil mode of operation and prioritizing power supply scenarios from the list of potential power supply scenarios that utilize the battery supply. In this regard, the preheat and broil modes are considered “high power” modes of operation where it is desirable to use the high power levels that may be provided from battery supply 236. By contrast, step 318 may include determining that the cooking appliance is operating in a steady state cooking mode of operation and prioritizing power supply scenarios from the list of potential power supply scenarios that utilize the main supply. In this regard, steady state cooking is considered a “low power” mode of operation where it is desirable to use main supply 232 if possible.

In the event that there is not a power supply scenario in which both the total main supply power draw falls below the maximum main supply power threshold and the total battery supply power draw falls below the maximum battery supply power threshold, step 320 may include modifying one or more power schedules that make up the power supply scenarios by reducing power of one or more of cooktop heaters 202 and/or chamber heaters 204. In this regard, steps 314, 316 of selecting the target power supply scenario may include determining that the combined power draw of the chamber heater and the cooktop heater exceeds a sum of the maximum main supply power draw and the maximum battery supply power draw. Step 320 may then include modifying the power schedule of at least one power supply scenario by changing one or more of heaters to be powered, heater power sources, power levels, and/or on/off timings to reduce the total main supply power draw below the maximum main supply power threshold and/or reduce the battery supply power draw below the maximum battery supply power threshold. For example, modifying the power schedule of at least one power supply scenario may include reducing the power level of a cooktop heater 202 while maintaining the power level of a chamber heater 204.

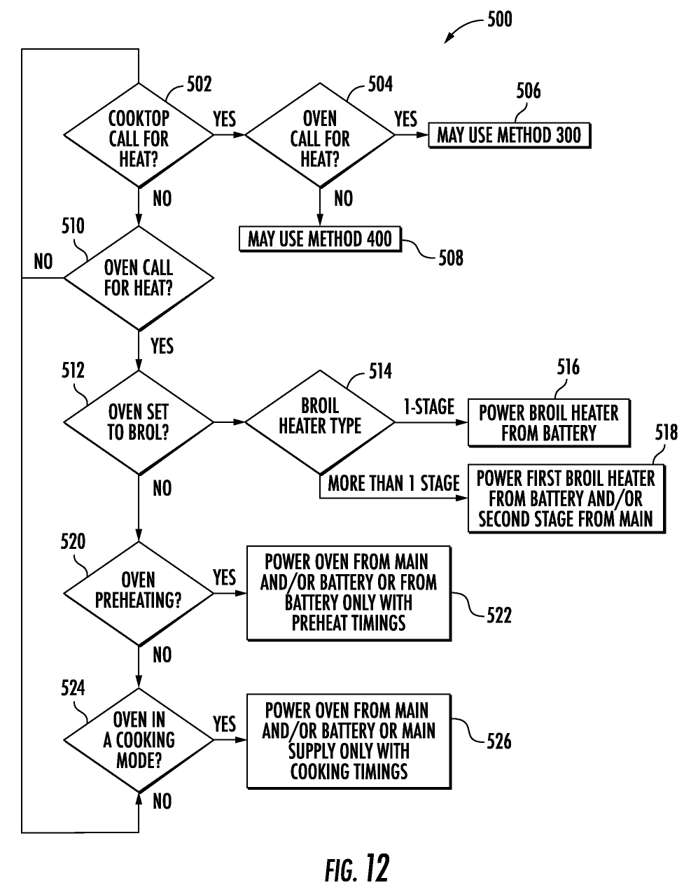

As noted above, if step 302 results in a determination that the cooktop 140 is calling for heat, and if step 304 results in a determination that the oven is not calling for heat, i.e., only cooktop 140 is calling for heat, step 306 may include using an alternate method to operate cooktop 140 (e.g., method 400). In this regard, referring now specifically to FIG. 11, method 400 may be used for operating only cooktop 140, i.e., method 400 provides operating protocols for supplying power from main supply 232, battery supply 236, or both. Accordingly, step 402 may include determining that cooktop 140 is calling for heat and step 404 may include determining that oven is not calling for heat. If the oven is also calling for heat, step 406 may include performing method 300, described above.

According to an example embodiment, method 400 may include determining that the chamber heater is off and receiving a call for heat from a cooktop heater at a target power level. Method 400 may further include determining a power schedule utilizing at least one of the main supply or the battery supply, wherein the power schedule is based at least in part on the target power level of the cooktop heater. Method 400 may further include operating the cooktop heater in accordance with the power schedule.

As used herein, when referring to operation of cooktop 140, the term “power schedule” may refer to the heaters to be powered, heater power sources, power levels, and/or on/off timings of operation of heating system 200. In this regard, controller 166 may utilize power switching system 240 to operate cooktop 140 in accordance with the prescribed power schedule. For example, the power schedule for heating a given cooktop heater 202 may include operating high side switch 262 associated with the target cooktop heater 202. The high-side switch 262 may be closed to power cooktop heater 202 and/or may operate to maintain the target power level of cooktop heater 202. The power schedule for heating a given cooktop heater 202 may also include operating high-side switch 242 to adjust the cooktop power source to one of the main supply, battery supply, or main and battery supply.

According to an example embodiment, method 400 includes, at step 408, determining whether a total cooktop set power is less than a maximum main supply power threshold. If the total cooktop set power is less than the maximum main supply power threshold, step 410 may include operating cooktop 140 solely using main supply 232, thereby preserving the power available from battery supply 236. By contrast, if the total cooktop set power is greater than the maximum main supply power threshold, step 412 may include powering cooktop 140 using either battery supply 236 or both main supply 232 and battery supply 236.

Thus, according to an example embodiment, determining the power schedule utilizing at least one of the main supply or the battery supply includes determining that the total cooktop set power is less than a maximum main supply power threshold and powering the cooktop heater(s) at the target power level(s) using only the main supply. Alternatively, determining the power schedule utilizing at least one of the main supply or the battery supply includes determining that the total cooktop set power is greater than a maximum main supply power threshold and powering the cooktop heater(s) at the target power level(s) using the battery supply or both main supply and battery supply.

Step 414 may further include determining whether the total cooktop set power is greater than a maximum main supply power threshold, a maximum battery supply power threshold, or a sum of the maximum main supply power threshold and a maximum battery supply power threshold. In this case, step 416 may include reducing the power level of one or more cooktop heaters to a reduced power level and powering the heater(s) using the main supply and the battery supply. For example, if the total power draw of cooktop heaters 202 exceeds the sum of maximum main supply power threshold and a maximum battery supply power threshold, the requested heating power for one or more cooktop heaters 202 may be reduced such that the total cooktop power draw is less than the sum of the maximum main supply power threshold and a maximum battery supply power threshold.

According to still another embodiment, cooktop heaters 202 may be powered by only battery supply 236. According to such an embodiment, steps 408 and 410 may be omitted. According to such an embodiment, method 400 would include powering cooktop heaters 202 using battery supply 236, determining that the total cooktop set power is greater than the maximum battery power supply threshold, and limiting the power supplied to the cooktop heaters 202 to the maximum battery power supply threshold, e.g., by reducing the power of one or more of cooktop heaters 202.

According to another example embodiment, multiple cooktop heaters 202 on cooktop 140 may be calling for heat simultaneously. For example, controller 166 may receive a call for heat from each of the plurality of cooktop heaters at a target power level. According to such an embodiment, method 400 may include determining that a sum of the target power levels of the plurality of cooktop heaters exceeds a maximum power threshold (e.g., the sum of a maximum main supply power threshold and a maximum battery supply power threshold) and reducing the target power levels of the plurality of cooktop heaters proportionally or as a percentage of the respective total power request. According to still another example embodiment, method 400 may include reducing the target power level of a target cooktop heater that is requesting the most power of the plurality of cooktop heaters. Thus, lower power elements may maintain their target power, while the highest power may be reduced such that the sum of target powers falls under the maximum power threshold.

According to still another embodiment, method 400 may include determining that the total cooktop set power is greater than a maximum main supply power threshold and less than a maximum battery supply power threshold. In such an embodiment, instead of splitting power distribution between main supply 232 and battery supply 236, method 400 may include powering the cooktop heaters at the target power levels using only battery supply 236. According to still other embodiments, method 400 may include determining that the total cooktop set power is greater than a maximum battery supply power threshold, reducing the target power level of one or more cooktop heaters to a reduced power level, and powering the cooktop heaters at the reduced power level using only the battery supply.

As noted above, if controller 166 receives a call from heat from cooking chamber 120 but cooktop 140 is not calling for heat, method 500 may be used to operate cooking appliance 100. In this regard, referring now specifically to FIG. 12, method 500 includes, at step 502, determining whether cooktop 140 is calling for heat. If cooktop 140 is calling for heat, step 504 may include determining whether cooking chamber 120 is calling for heat. If both cooktop 140 and cooking chamber 120 are calling for heat, step 506 may include using method 300 as described above. By contrast, if only cooktop 140 is calling for heat, step 508 may include using method 400 as described above.

Step 510 includes determining whether cooking chamber 120 is calling for heat, and if cooking chamber 120 is calling for heat and cooktop 140 is not, method 500 may include determining a power schedule (e.g., heaters to be powered, heater power sources, power levels and/or on/off timings) for operating chamber heaters 204 based at least in part on the operating mode of the oven (e.g., broil mode, preheat mode, or steady state cooking mode). Specifically, step 512 may include determining whether the oven is operating in a broil mode of operation. If the oven is in broil mode, step 514 may include determining the broil heater type, e.g., single stage versus multiple stage broil heaters. If the broil heater type is a single stage broil heating element, step 516 may include operating broil heating element using only battery supply 236. By contrast, if the broil heater type is a multiple stage heating element, step 518 includes operating broil heating element using both main supply 232 and battery supply 236.

If the cooking appliance is not operating in the broil mode, step 520 may include determining whether the oven is operating in a preheat mode of operation. If the oven is preheating, step 522 may include powering the oven using the battery supply 236 only or both main supply 232 and battery supply 236 using preheat timings or a preheat timing schedule. In this regard, “preheat timings” refer to a power schedule of one or more oven heaters (e.g., a bake heating element and a broil heating element), including a sequence of toggling heaters on and off in accordance with a duty cycle, based on a target steady state oven temperature, and/or an upper heat threshold selected as a function of the target steady state oven temperature.

If the cooking appliance is not operating in the broil mode or the preheat mode, step 524 may include determining whether the oven is operating in a steady state cooking mode of operation. If the oven is in steady state cooking mode, step 526 may include powering the oven using either main supply 232 or both main supply 232 and battery supply 236 using steady state cooking timings or a cooking timing schedule. In this regard, “cooking timings” refer to a power schedule of one or more oven heaters (e.g., a bake heating element and a broil heating element), including a sequence of toggling heaters on and off in accordance with a duty cycle, based on a target steady state oven temperature, and/or upper and lower heat thresholds selected as a function of the target steady state oven temperature.

In other words, method 500 may include determining that the cooktop heater is off, receiving a call for heat in the cooking chamber, determine a power schedule utilizing at least one of the main supply or the battery supply, wherein the power schedule is based at least in part on whether the cooking appliance is operating in a broil mode, a preheat mode, or a steady state cooking mode, and operating the oven heaters in accordance with the power schedule.

As noted above, if broil heating element 206 has a single stage and cooking appliance 100 is operating in the broil mode, operating the oven heaters in accordance with the power schedule may include powering broil heating element 206 entirely from battery supply 236. By contrast, if broil heating element 206 includes a first stage and a second stage and cooking appliance 100 is operating in the broil mode, operating the oven heaters in accordance with the power schedule may include powering the first stage of the broil heaters from battery supply 236 and the second stage from main supply 232.

In addition, if cooking appliance 100 is operating in the preheat mode, the power schedule may include powering the oven heaters using battery supply 236 or main supply 232 and battery supply 236 in accordance with predetermined preheat timings. By contrast, if cooking appliance 100 is operating in the steady state cooking mode, the power schedule may include powering the oven heaters using main supply 232 or main supply 232 and battery supply 236 in accordance with predetermined steady state timings. Notably, the energy or power drawn from battery supply 236 during a call for heat may be lower when using the predetermined steady state timings than when using the predetermined preheat timings.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cooking appliance comprising:
a cabinet;
a cooktop mounted to the cabinet and having one or more cooktop heaters;
a main power connection to a main supply of electrical power at a first voltage;
an auxiliary power connection to a battery supply of electrical power at a second voltage; and
a controller operably coupled to the main power connection, the auxiliary power connection, and the one or more cooktop heaters, the controller being configured to:
receive a call for heat from the one or more cooktop heaters at a target power level;
determine a power schedule utilizing at least one of the main supply or the battery supply, wherein the power schedule is based at least in part on the target power level of the one or more cooktop heaters; and
operate the one or more cooktop heaters in accordance with the power schedule.

2. The cooking appliance of claim 1, wherein determining the power schedule utilizing at least one of the main supply or the battery supply comprises:
determining that the target power level is less than a maximum main supply power threshold; and
powering the one or more cooktop heaters at the target power level using only the main supply.

3. The cooking appliance of claim 1, wherein determining the power schedule utilizing at least one of the main supply or the battery supply comprises:
determining that the target power level is greater than a maximum main supply power threshold; and
powering the one or more cooktop heaters at the target power level using the battery supply or the main supply and the battery supply.

4. The cooking appliance of claim 1, wherein determining the power schedule utilizing at least one of the main supply or the battery supply comprises:
determining that the target power level is greater than a sum of a maximum main supply power threshold and a maximum battery supply power threshold;
reducing the target power level to a reduced power level; and
powering the one or more cooktop heaters at the reduced power level using the main supply and the battery supply.

5. The cooking appliance of claim 1, wherein determining the power schedule utilizing at least one of the main supply or the battery supply comprises:
determining that the target power level is greater than a maximum main supply power threshold and less than a maximum battery supply power threshold; and
powering the one or more cooktop heaters at the target power level using only the battery supply.

6. The cooking appliance of claim 1, wherein determining the power schedule utilizing at least one of the main supply or the battery supply comprises:
determining that the target power level is greater than a maximum battery supply power threshold;
reducing the target power level to a reduced power level; and
powering the one or more cooktop heaters at the reduced power level using only the battery supply.

7. The cooking appliance of claim 1, wherein the controller is further configured to:
receive a call for heat from each of the one or more cooktop heaters at a target power level;
determining that a sum of the target power levels of the one or more cooktop heaters exceeds a maximum power threshold; and
reducing the target power levels of the one or more cooktop heaters proportionally.

8. The cooking appliance of claim 1, wherein the controller is further configured to:
receive a call for heat from each of the one or more cooktop heaters at a target power level;
determining that a sum of the target power levels of the one or more cooktop heaters exceeds a maximum power threshold; and
reducing the target power level of a target cooktop heater of the one or more cooktop heaters that is requesting the most power.

9. The cooking appliance of claim 1, wherein the one or more cooktop heaters comprises an induction heating element.

10. The cooking appliance of claim 1, wherein the first voltage is 120VAC and the second voltage is 230VDC.

11. The cooking appliance of claim 1, wherein the battery supply is a battery stored within the cooking appliance.

12. The cooking appliance of claim 1, wherein the battery supply is a home battery supply in communication with the cooking appliance.

13. The cooking appliance of claim 1, further comprising:
a power switching system configured to selectively couple the main supply and the battery supply to the one or more cooktop heaters.

14. A method of operating a cooking appliance, the cooking appliance comprising a cabinet, a cooktop mounted to the cabinet and having one or more cooktop heaters, a main power connection to a main supply of electrical power at a first voltage, and an auxiliary power connection to a battery supply of electrical power at a second voltage, the method comprising:
receiving a call for heat from the one or more cooktop heaters at a target power level;
determining a power schedule utilizing at least one of the main supply or the battery supply, wherein the power schedule is based at least in part on the target power level of the one or more cooktop heaters; and
operating the one or more cooktop heaters in accordance with the power schedule.

15. The method of claim 14, wherein determining the power schedule utilizing at least one of the main supply or the battery supply comprises:
determining that the target power level is less than a maximum main supply power threshold; and
powering the one or more cooktop heaters at the target power level using only the main supply.

16. The method of claim 14, wherein determining the power schedule utilizing at least one of the main supply or the battery supply comprises:
determining that the target power level is greater than a maximum main supply power threshold; and
powering the one or more cooktop heaters at the target power level using the battery supply or the main supply and the battery supply.

17. The method of claim 14, wherein determining the power schedule utilizing at least one of the main supply or the battery supply comprises:
determining that the target power level is greater than a sum of a maximum main supply power threshold and a maximum battery supply power threshold;
reducing the target power level to a reduced power level; and
powering the one or more cooktop heaters at the reduced power level using the main supply and the battery supply.

18. The method of claim 14, wherein determining the power schedule utilizing at least one of the main supply or the battery supply comprises:
determining that the target power level is greater than a maximum main supply power threshold and less than a maximum battery supply power threshold; and
powering the one or more cooktop heaters at the target power level using only the battery supply.

19. The method of claim 14, wherein determining the power schedule utilizing at least one of the main supply or the battery supply comprises:
determining that the target power level is greater than a maximum battery supply power threshold;
reducing the target power level to a reduced power level; and
powering the one or more cooktop heaters at the reduced power level using only the battery supply.

20. The method of claim 14, further comprising:
receive a call for heat from each of the one or more cooktop heaters at a target power level;
determining that a sum of the target power levels of the one or more cooktop heaters exceeds a maximum power threshold; and
reducing the target power levels of the one or more cooktop heaters proportionally.
